(19) United States
(12) Patent Application Publication
(10) Pub. No.: US 2015/0378041 A1
(43) Pub. Date: Dec. 31, 2015

(54) SUBTERRANEAN FORMATION IMAGING METHOD AND SYSTEM

(71) Applicant: DEVON CANADA CORPORATION, Calgary (CA)

(72) Inventors: Warren Foster Peter MacPHAIL, Calgary (CA); Lars HINRICHS, Calgary (CA); Glenn Allen LARSON, Calgary (CA)

(21) Appl. No.: 14/753,998

(22) Filed: Jun. 29, 2015

Related U.S. Application Data
(60) Provisional application No. 62/019,048, filed on Jun. 30, 2014.

(51) Int. Cl. G01V 1/50

(52) U.S. Cl. CPC G01V 1/50

(57) ABSTRACT

A method and a system for obtaining information for imaging a subterranean formation are provided. The method comprises emitting sonic or percussive signals from one or more point source locations in or near the subterranean formation; detecting the signals at one or more receiver locations; and processing the signals to calculate the geometry of the ray paths travelled by the signals in the subterranean formation. The system comprises one or more signal sources for generating sonic or percussive signals; a receiver for receiving the signals; and a processor for processing the signals.

### FIELD

The invention relates to a method and a system for imaging a subterranean formation.

### BACKGROUND

For operations involving a wellbore in a subterranean formation, such as a hydrocarbon reservoir, it may be helpful to have information on the location and type of physical features in the formation in the vicinity of the wellbore.

### SUMMARY OF THE INVENTION

In accordance with a broad aspect of the present invention, there is provided a method for obtaining information about a subterranean formation, the method comprising: emitting one or more sonic or percussive signals from one or more point source locations in or near the subterranean formation; detecting the one or more signals at one or more receiver locations; and processing the one or more signals detected at the one or more receiver locations to calculate the geometry of one or more ray paths travelled by each of the one or more signals from the one or more point source locations to the one or more receiver locations.

In accordance with another broad aspect of the present invention, there is provided a system for obtaining information about a subterranean formation having one or more wellbores extending therein, the system comprising: one or more signal sources for generating sonic or percussive signals at one or more point source locations in or near a first of the one or more wellbores; a receiver located in or near a second of the one or more wellbores, the receiver for receiving the sonic or percussive signals generated by the one or more signal sources; and a processor in communication with the receiver for recording and analyzing the sonic or percussive signals received by the receiver.

### BRIEF DESCRIPTION OF THE DRAWINGS

Drawings are included for the purpose of illustrating certain aspects of the invention. Such drawings and the description thereof are intended to facilitate understanding and should not be considered limiting of the invention. Drawings are included, in which:

FIG. 1 is a schematic diagram illustrating one embodiment of the present invention with respect to a pair of wells;

FIG. 2a and FIG. 2b are graphs showing sample data collectable in accordance with embodiments of the present invention;

FIG. 3 is a schematic diagram illustrating one embodiment of the present invention with respect to a fractured horizontal well;

FIG. 4 is a schematic diagram illustrating one embodiment of the invention with respect to a fractured horizontal well having a hydrocarbon recovery system of alternating zones of injection and production; and

FIG. 5 is a schematic diagram illustrating another embodiment of the present invention with respect to a pair of wells near a vertical well.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

In this description, the words “sound”, “acoustic”, and “sonic” (and variations thereof) have the same meaning and are interchangeable. The words, “percussion”, “pressure pulses”, “vibration” (and variations thereof) have the same meaning and are interchangeable. The words “signal” and “energy wave” have the same meaning and are interchangeable.

An aspect of the present invention is to provide a method and a system for generating an image of a subterranean formation. In one embodiment, the image is generated by analyzing signals that are transmitted through the subterranean formation. More specifically, signals are transmitted from a source to a receiver, both of which are positioned in or near the formation. By analyzing the waveform and arrival time of the signals, information and/or an image of the subterranean formation can be generated.

The image obtained may be useful for managing the recovery of hydrocarbons from the formation and improving the efficiency of same.

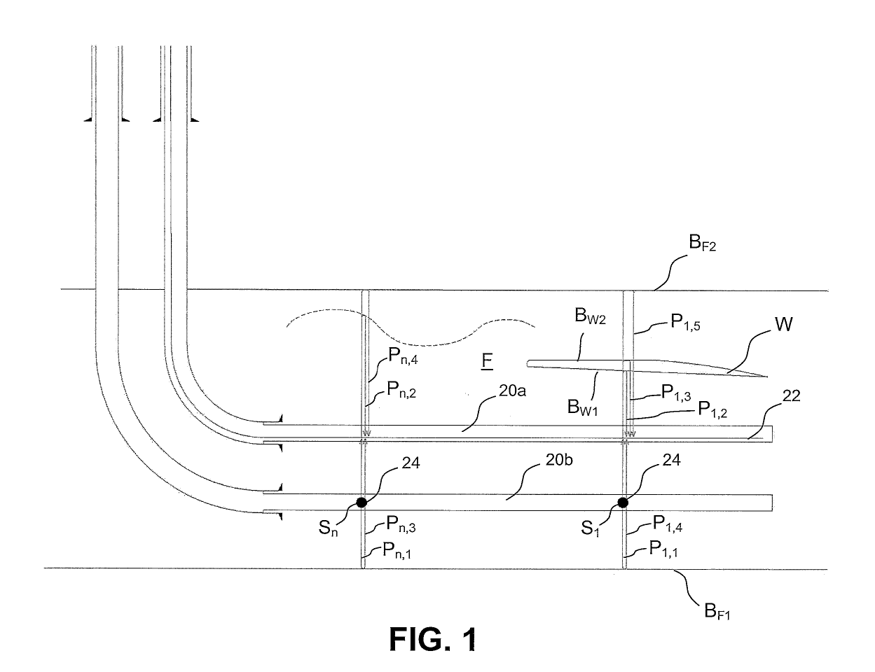

With reference to FIG. 1, a pair of wellbores 20a, 20b run alongside each other in a subterranean formation F. Wellbores 20a and 20b are shown as horizontal wells, which are typical, for example, for steam-assisted gravity drainage (“SAGD”) operations. While the present invention is described with respect to horizontal wells, the invention described herein may be used with other wells, including vertical wells, deviated wells, etc.

In the sample embodiment shown in FIG. 1, wellbores 20a, 20b are spaced apart from one another. Wellbores 20a, 20b may be substantially parallel to one another, but not necessarily. A receiver 22 is placed in wellbore 20a. Receiver 22 is a telecom fiber, such as a single-mode or multi-mode optical fiber, or any type of receiver having spatial resolution capabilities. Preferably, receiver 22 is a telecom fiber that is capable of detecting signals along substantially its entire length simultaneously (sometimes referred to as “spatial recognition”). In another example, the receiver may be a geophone.

In one embodiment, receiver 22 is optical fiber extending axially inside wellbore 20a. The optical fiber may be permanently or temporarily installed in wellbore 20a. The optical fiber is configured to detect sonic wave energy along at least a portion of the length of the horizontal wellbore 20a. The optical fiber is capable of acoustic sensing and/or detection of changes in stress along its length. The receiver is in communication with surface equipment for receiving and processing signals from the receiver.

In the illustrated embodiment, at least one signal source 24 is installed in wellbore 20b. Alternatively, the signal source is installed in wellbore 20a, the same wellbore where the receiver is positioned. The signal source is configured to emit acoustic and/or percussive signals automatically or selectively. The signal source may be, for example, a low or high frequency sonic source or a percussion source (e.g. 5 Hz to 10 kHz), such as for example, a piezoelectric device, an air hammer, a tool for dislodging downhole equipment (“JAR”), a speaker, a hydraulic pulse, etc. Preferably, the signal sources are placed near the receiver (e.g. about 0 to 150 m) and/or below the cap rock and as a pulse.

In a further preferred embodiment, the signal source is moveable axially within the wellbore such that it can act as a signal point source at various locations (S₁ . . . Sₙ) along the length of the wellbore, at different times. Alternatively, multiple stationary sources may be deployed along the wellbore at various locations (S1 . . . Sn) to reduce or eliminate the need to move the signal sources. Signals may be emitted sequentially or simultaneously by multiple sources. The several point source locations (S₁ . . . Sₙ) may be used in a distributed array pattern along the length of the wellbore in which the signal source(s) is installed. Distributed array pattern means that one or more sources are emitting signals simultaneously but at different point source locations. If simultaneously emitted, the reflected rays may be received simultaneously along the full length of the receiver within the formation. The signals received by the receiver may be the same whether the signals from the point sources are emitted simultaneous or sequentially. An image of the features in the formation in the region of the wellbore may be generated from the resulting data, especially when two or more signal sources are used.

In one embodiment, the signal source can selectively generate signals of two or more different frequencies or frequency ranges, either simultaneously or separately (“multi-frequency signal source”). Alternatively, multiple signal sources may be deployed and each signal source is capable of generating signals of one frequency or one range of frequencies (“single-frequency signal source”). In another embodiment, a combination of multi-frequency and single-frequency signal sources may be used.

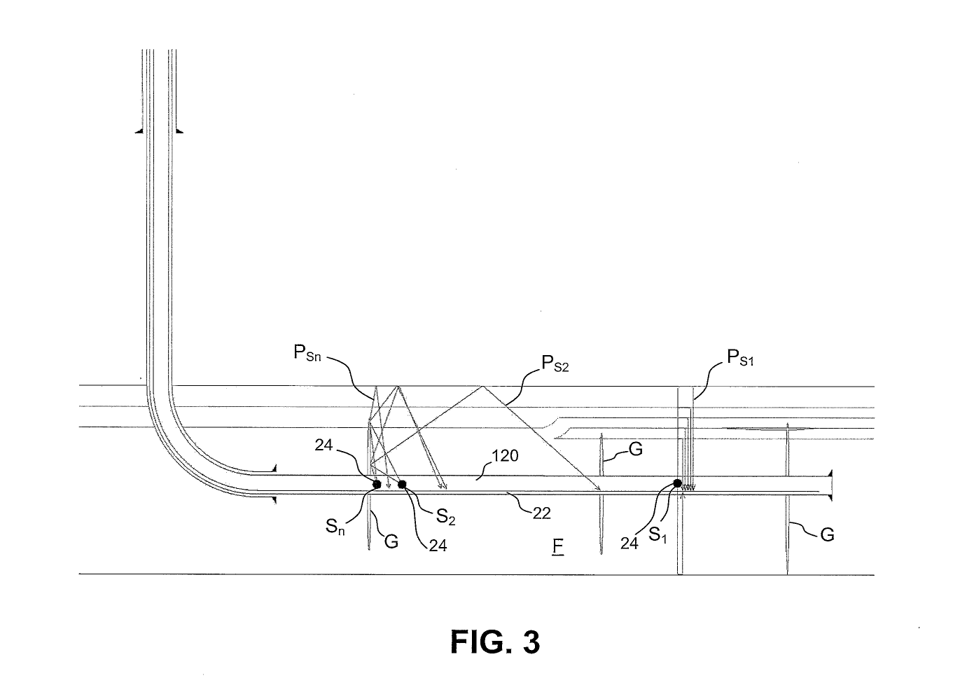

FIG. 3 illustrates another sample embodiment of the present invention, wherein a receiver 22 and at least one signal source 24, both as described above with respect to FIG. 1, are installed in the same wellbore 120 in subterranean formation F. In this embodiment, the formation has a plurality of manmade hydraulic fractures G or other geological features that are in fluid communication with or are adjacent to wellbore 120.

When the signal source emits a signal, which includes an acoustic signal and/or a pressure signal, the ray path of the signal may take a number of different routes to reach the receiver. The routes taken by the signal may depend on the physical features of the formation and/or the wellbore. For example, a signal emitted by the point source may take various routes to reach the receiver:
a) a direct ray path (e.g. P_{1,1} in FIG. 1) through the formation from the point source to the receiver (“tomography”);
b) a refracted ray path (e.g. P_{S2} and P_{Sn} in FIG. 3) through certain physical features of the formation (“refraction”) ; and
c) a reflected ray path (e.g. P_{1,2}, P_{1,3}, P_{1,4}, P_{1,5} in FIG. 1 and P_{S1} in FIG. 3) from certain physical features of the formation (“reflection”).

The resulting waveform and the arrival time of the signal detected by the receiver depend on the ray path of the signal and the location and type of physical features encountered on route by the signal. The signal may have reflected from or refracted through certain physical features of the formation along its path between the point source and the receiver.

Examples of features that may affect the waveform as seen by the receiver include formation heterogeneities, formation strata, fluid levels within the formation, such as underlying water or oil and gas interfaces, bitumen and steam interfaces, stimulation fluid and formation hydrocarbon interfaces, local depletion of reservoir hydrocarbons or water, injected fluid concentration and regions of immiscibly and miscibly mixed injected fluid and reservoir fluid as a result of injection for an EOR scheme, influx or movement of water or gas due to natural reservoir drive, wormholes due to cold heavy oil production with sand (CHOPS), location or condition of created lateral holes or fishbones, natural fractures (whether cemented or open), hydraulic fractures, natural fracture or hydraulic fracture apertures, hydraulic fracture proppant, formation inclusions such mud lenses, shale or dipping interbedded heterolithic strata within a reservoir sand volume, as well as features of the well completion equipment, casing, primary cement or segmented areas between openhole packers. Localized poroelastic formation stress effects and/or adiabatic temperature change effects due to reservoir pressure variance and in-situ formation fluid compressibility may also affect the sonic travel time through the formation and thus may have an influence on the received waveform.

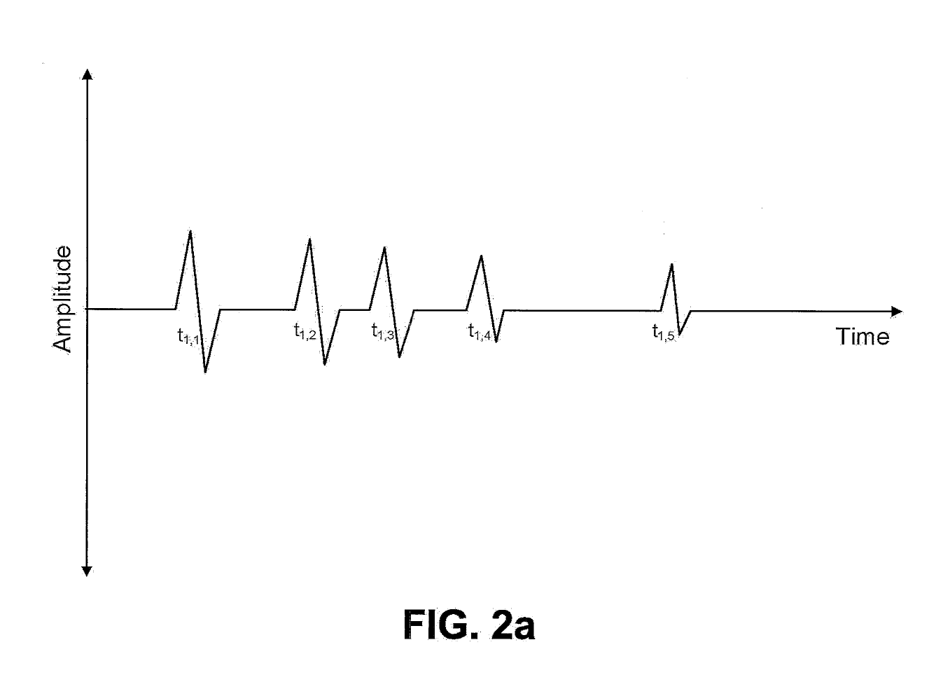

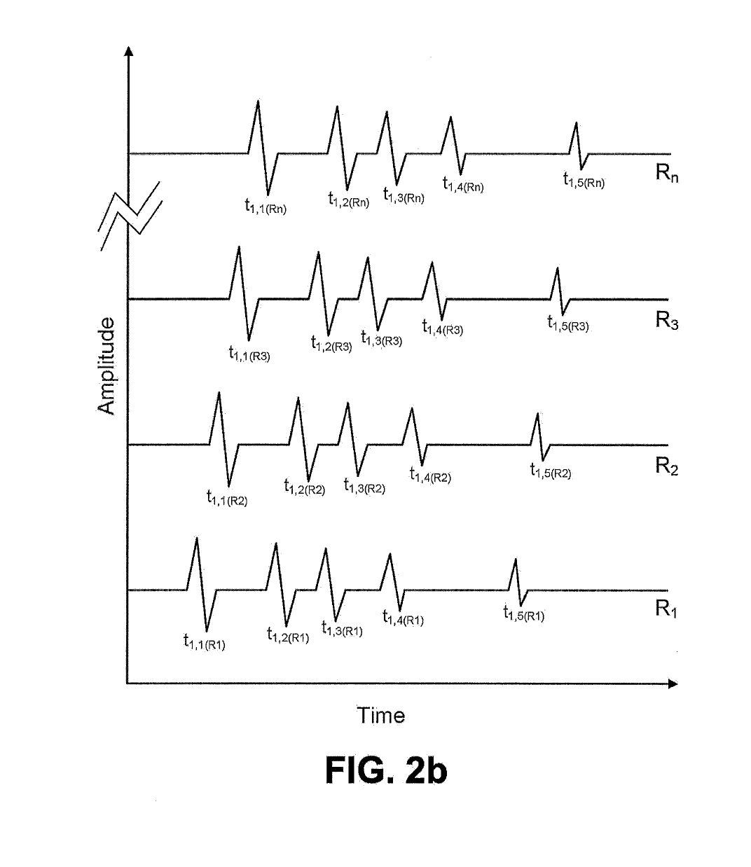

Referring to FIGS. 1, 2a, 2b, and 3, the signals received by the receiver may be plotted along a time axis to provide a graphical representation for data analysis. FIG. 2a is a graphical representation of signals which may be detected by the receiver in a sample embodiment. With reference to FIGS. 1 and 2a, a signal is emitted by point source S₁ at time 0. The receiver first detects the signal at time t_{1,1} as the signal travels directly from the point source to the receiver via ray path P_{1,1}. The signal continues to travel through the formation and encounters a first boundary B_{W1} of a physical feature W in the formation. Part of the signal is reflected back to the receiver via ray path P_{1,2} and the receiver sees this signal at time t_{1,2}, which is subsequent to time t_{1,1}. When the signal encounters a second boundary B_{W2} of the physical feature W, the second boundary being further away from S₁ than the first boundary, part of the signal is reflected back via ray path P_{1,3} and is received by the receiver at time t_{1,3}, subsequent to time t_{1,2}. hen the signal encounters the upper boundary B_{F2} of the formation, which is further away from S₁ than the second boundary B_{W2}, part of the signal is reflected back via ray path P_{1,5} and is detected by the receiver at time t_{1,5}. The signal emitted by point source S₁ at time 0 is also detected by the receiver at time t_{1,4} when a reflection of a portion of the signal from a lower boundary B_{F1} of the formation reaches the receiver via ray path P_{1,4}.

In another embodiment, the receiver may comprise more than one receiver each located at a different location (R₁ . . . Rₙ) in or near the wellbore. Each receiver location R may receive the same signal from the same signal source at a different time, depending on the location of the receiver relative to the signal source. For example, with reference to FIGS. 1 and 2b, a signal is emitted by point source S₁ at time 0. The receiver at location R₁ first detects the signal from S₁ at time t_{1,1(R1)} as the signal travels directly from the point source to the receiver at location R₁. The receivers at locations R₂, R₃, . . . Rₙ detects the signal from S₁ at time t_{1,1(R2)}, t_{1,1(R3)}, . . . t_{1,1(Rn)}, respectively, as the signal travels directly from the point source to each of the receivers. The value of each of time t_{1,1(R2)}, t_{1,1(R3)}, . . . t_{1,1(Rn)} may be lesser or greater than t_{1,1(R1)}, depending on the location of each receiver relative to S₁. In the sample embodiment shown in FIG. 2b, R₁ is the closest to S₁ and S₂, S₃, . . . Sₙ are respectively increasingly further away from S₁ than R₁.

The signal continues to travel through the formation and encounters a first boundary B_{W1} of a physical feature W in the formation. Part of the signal is reflected back to the receiver at location R₁ and the receiver detects this signal at time t_{1,2(R1)}, which is subsequent to time t_{1,1(R1)}. The receivers at locations R₂, R₃, . . . Rₙ detects the same signal from S₁ at time t_{1,2(R2)}, t_{1,2(R3)}, . . . t_{1,2(Rn)}, respectively, as the signal is reflected back to each of the receivers. Times t_{1,2(R2)}, t_{1,2(R3)}, . . . t_{1,2(Rn)} are subsequent to times t_{1,1(R2)}, t_{1,1(R3)}, . . . t_{1,1(Rn)}, respectively.

When the signal encounters a second boundary B_{W2} of the physical feature W, the second boundary being further away from S₁ than the first boundary, part of the signal is reflected back to the receiver at location R₁ and is received thereby at time t_{1,3(R1)}, subsequent to time t_{1,2(R1)}. The receivers at locations R₂, R₃, . . . Rₙ detects the same signal from S₁ at time t_{1,3(R2)}, t_{1,3}(R3), . . . t_{1,3(Rn)}, respectively, as the signal is reflected back to each of the receivers from second boundary B_{W2}. Times t_{1,3(R2)}, t_{1,3(R3)}, . . . t_{1,3(Rn)} are subsequent to times t_{1,3(R2)}, t_{1,2(R3)}, . . . t_{1,2(Rn)}, respectively.

When the signal encounters the upper boundary B_{F2} of the formation, which is further away from S₁ than the second boundary B_{W2}, part of the signal is reflected back to the receiver at location R₁ and is detected by thereby at time t_{1,5(R1)}, subsequent to time t_{1,3(R1)}. The receivers at locations R₂, R₃, . . . Rₙ detects the same signal from S₁ at time t_{1,5(R2)}, t_{1,5(R3)}, . . . t_{1,5(Rn)}, respectively, as the signal is reflected back to each of the receivers from upper boundary B_{F2}. Times t_{1,5(R2)}, t_{1,5(R3)}, . . . t_{1,5(Rn)} are subsequent to times t_{1,3(R2)}, t_{1,3(R3)}, . . . t_{1,3(Rn)}, respectively.

The signal emitted by point source S₁ at time 0 is also detected by the receiver at location R₁ at time t_{1,4(R1)} when a reflection of a portion of the signal from a lower boundary B_{F1} of the formation reaches the receiver at location R₁. The receivers at locations R₂, R₃, . . . Rₙ detects the same signal from S₁ at time t_{1,4(R2)}, t_{1,4(R3)}, . . . t_{1,4(Rn)}, respectively, as the signal is reflected back to each of the receivers from lower boundary B_{F1}. Times t_{1,4(R2)}, t_{1,4(R3)}, . . . t_{1,4(Rn)} may be subsequent to times t_{1,3(R2)}, t_{1,3(R3)}, . . . t_{1,3(Rn)}, respectively.

The geometry of the source-receiver ray paths can be calculated by knowing: (i) the position of the one or more point source locations S₁ . . . Sₙ; (ii) the position of the one or more receiver locations R₁ . . . Rₙ; (iii) the velocity of the sonic signal through different types of densities of materials; and (iv) the timing of the signals received by each receiver. Preferably, the calculation includes all possible combinations of the point source and receiver locations (i.e. S₁ in relation to each of R₁ . . . Rₙ, S₂ in relation to each of R₁ . . . Rₙ, to . . . Sₙ in relation to each of R₁ . . . Rₙ). Superimposing the recorded signals from multiple point source locations and multiple receiver locations may help reduce noise and enhance the quality and accuracy of the resulting data. The resulting data can be processed by software using a processor to calculate the geometry of the source-receiver ray paths and a three dimensional model for the subsurface within the vicinity of the wellbore(s) can be generated therefrom by software using substantially the same geometric principals as those used in medical imaging (i.e. CAT scans). Furthermore, the amplitude of the signal and its frequency content as detected by the receiver may also help identify the characteristics of the physical features encountered by the signal.

Certain originating signal source frequencies and/or frequency ranges may provide better signals for detection by the receiver. Also certain frequencies and/or frequency ranges may provide better signals for detecting certain types of physical features in the formation. Therefore, it may be useful in some embodiments to generate signals of difference frequencies. For example, a first set of data is collected from signals of a first originating frequency (or frequency range) and a second set of data is collected from signals of a second originating frequency (or frequency range), and the first and second sets of data are combined to generate an image of the formation. Of course, more than two sets of data (and two frequencies or frequency ranges) may be combined.

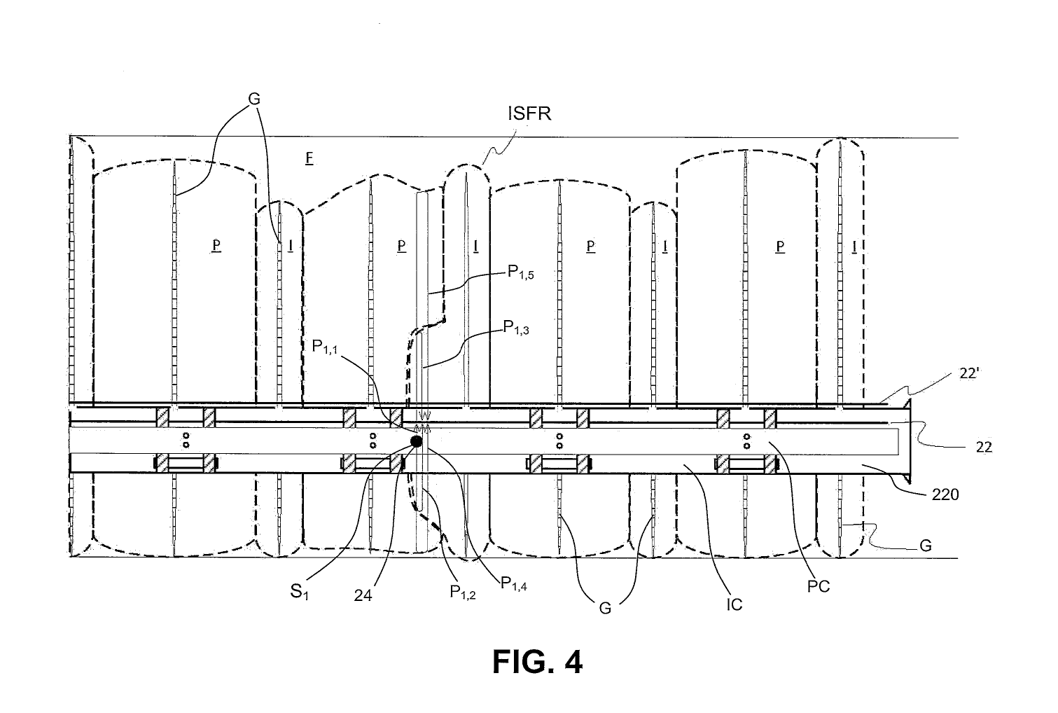

In another sample embodiment, with reference to FIG. 4, the imaging technique of the present invention may be used for imaging the injection swept formation region ISFR and boundaries between production and injection regions in a formation. In this embodiment, a wellbore 220 extends through a formation F having a plurality of fractures G. Wellbore 220 has a production conduit PC and an injection conduit IC which are fluidly sealed from one another by, for example, packers. The injection conduit is in communication with some of the plurality of fractures (“injection fractures”) and the production conduit is in communication with other fractures of the plurality of fractures (“production fractures”). Injection fluid is pumped into the injection fractures via the injection conduit, thereby increasing the fluid pressure near the injection fractures in the formation. The increase in fluid pressure urges at least some of the fluids in the formation to flow into the production conduit via the production fractures. The formation fluids can then be produced from the production conduit.

In the sample embodiment shown in FIG. 4, there are regions in the formation where there consists mainly injection fluids (“injection regions”) and there are regions in the formation where there consists mainly production fluids (“production regions”). The interface between an injection region and a production region is referred to herein as an injection-production boundary. The interface between an injection region and a region of the formation that is neither an injection region nor a production region is referred to herein as an injection-formation boundary. The interface between a production region and a region of the formation that is neither an injection region nor a production region is referred to herein as a production-formation boundary.

In the sample embodiment, a signal point source 24 is located at point source location S₁ inside the wellbore, for example at an axial location on or inside the production conduit. A receiver 22 is placed inside the wellbore, for example extending axially along the injection conduit. Alternatively or additionally, a receiver 22′ is placed outside the wellbore and receiver 22′ may extend axially along a length of the wellbore.

With reference to both FIGS. 2a and 4, a signal is emitted by point source 24 at location S₁ at time 0. Receiver 22 detects the signal at time t_{1,1} as the signal travels directly from the point source to the receiver via ray path P_{1,1}. The signal continues to travel through the formation and encounters an injection-production boundary in the formation. Part of the signal is reflected back to the receiver via ray path P_{1,3} and the receiver sees this signal at time t_{1,3}, which is subsequent to time t_{1,1}. The signal also encounters another injection-production boundary in the formation and part of the signal is reflected back to the receiver via ray path P_{1,2}. The receiver detects this reflected signal at time t_{1,2}, which is subsequent to time t_{1,1}. When the signal encounters a production-formation boundary, part of the signal is reflected back via ray path P_{1,4} and is received by the receiver at time t_{1,2}, subsequent to time t_{1,2}. When the signal encounters another production-formation boundary, part of the signal is reflected back via ray path P_{1,5} and is detected by the receiver at time t_{1,5}.

By processing the signal data received by one or more receivers from one or more signal point sources (e.g. by analyzing the shape and amplitude of the signal, and the arrival times of the signal), an image of the formation through which the signal travelled may be generated. In a sample application, images of the formation over time can be generated and analyzed, which may be useful in detecting and monitoring changes in the reservoir (e.g. changes in fluid density in the reservoir) and its response to enhanced oil recovery methods and/or reservoir fluid depletion.

While the sample embodiments illustrated in the Figures show substantially horizontal wells, the present invention may be used with any subterranean well, including substantially vertical wells, deviated wells, vertical sections of horizontal well, etc.

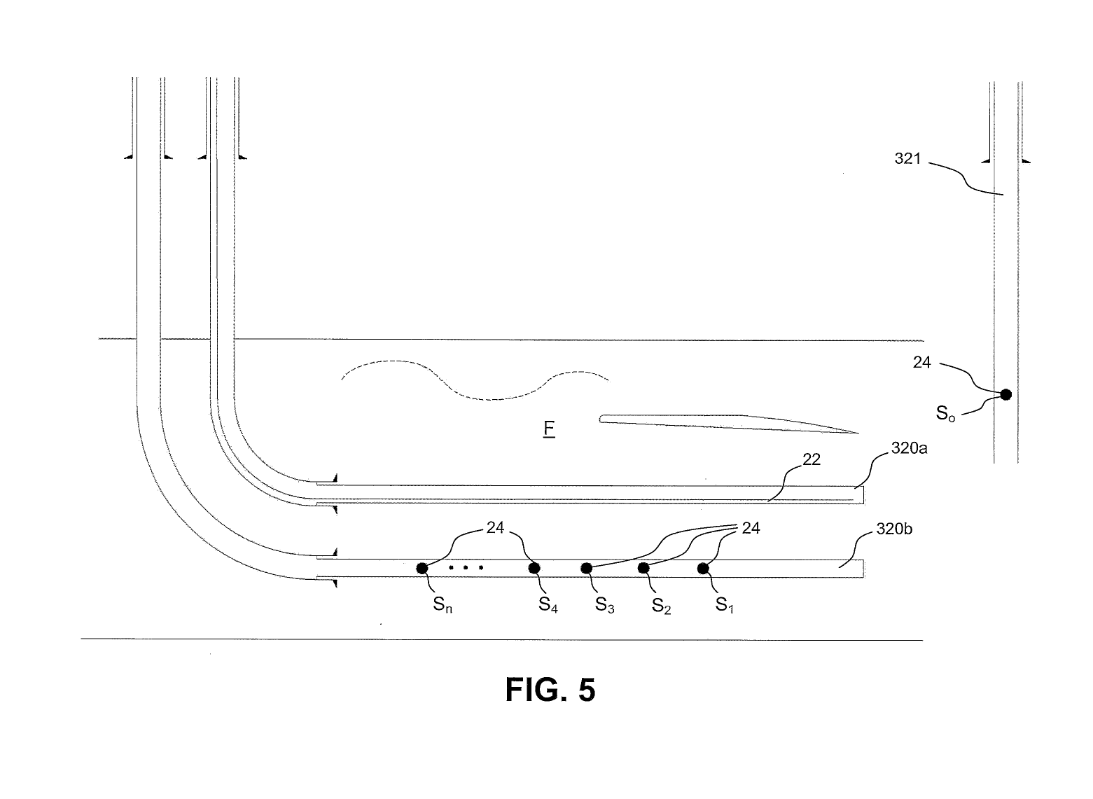

With reference to FIG. 5, a first wellbore 320a and a second wellbore 320b run alongside each other in a subterranean formation F. Wellbores 320a and 320b are shown as horizontal wells, which are typical, for example, for steam-assisted gravity drainage (“SAGD”) operations. While wells 320a and 320b are shown as horizontal wells, they may be other types of wells in other embodiments. Wellbores 320a, 320b are spaced apart from one another. Wellbores 320a, 320b may be substantially parallel to one another, but not necessarily. A third wellbore 321 is within the vicinity of the first wellbore 320a. For example, the shortest distance between the third wellbore and the first wellbore is about 0 to 150 m. In this sample embodiment, the third wellbore is a vertical well, but it may be another type of well in other embodiments.

Receiver 22 is placed in the first wellbore 320a. At least one signal source 24 is installed in wellbore 320b. Alternatively, the signal source is installed in wellbore 320a, the same wellbore where the receiver is positioned. In one embodiment, there are multiple signal sources at various signal source locations S₁, S₂, . . . Sₙ along the length of wellbore 320b. In another embodiment, one signal source 24 is placed in wellbore 320b and the signal source is movable axially along the length of wellbore 320b to provide one or more signal source locations S₁, S₂, . . . Sₙ. Alternatively or additionally, a signal source 24 is placed in wellbore 321 at location S₀. In another embodiment, more than one signal source and/or signal source locations are provided in wellbore 321.

In the illustrated embodiment shown in FIG. 5, there are a number of possible ways to obtain data to generate a three-dimensional image of formation F in accordance with the above described methods. For example:
1) one or more signals at a particular frequency (or frequency range) are generated at S₀ and the signal(s) is detected by receiver 22 at different times t;
2) one or more signals at two or more frequencies (or frequency ranges) are generated at S₀, simultaneously and/or asynchronously, and the signal(s) is detected by receiver 22 at different times t;
3) one or more signals at a particular frequency (or frequency range) are generated at S₁ and the signal(s) is detected by receiver 22 at different times t;
4) one or more signals at two or more frequencies (or frequency ranges) are generated at S₁, simultaneously and/or asynchronously, and the signal(s) is detected by receiver 22 at different times t;
5) one or more signals at a particular frequency (of frequency range) are generated at each of S₁, S₂, . . . Sₙ, simultaneously and/or asynchronously, and the signals are detected by receiver 22 at different times t;
6) one or more signals at two or more frequencies (or frequency ranges) are generated at each of S₁, S₂, . . . Sₙ, simultaneously and/or asynchronously, and the signals are detected by receiver 22 at different times t;
7) method 1) or 2) and method 3);
8) method 1) or 2) and method 4);
9) method 1) or 2) and method 5); and
10) method 1) or 2) and method 5).

Other ways or signal source and receiver combinations to obtain data are possible.

A method for obtaining an image of a subterranean formation (e.g. a hydrocarbon reservoir) is described herein. In one embodiment, the method comprises:
emitting one or more sonic or percussive signals from one or more point source locations in or near the subterranean formation;
detecting the one or more signals at one or more receiver locations; and
processing the one or more signals detected by the receiver to calculate the geometry of one or more ray paths travelled by each of the one or more signals from the one or more point source locations to the receiver.

In a further embodiment, the method further comprises generating an image of the subterranean formation using the calculated geometry of the one or more ray paths. Processing the one or more signals includes recording the timing of the one or more signals as detected at the one or more receiver locations. The geometry of the one or more ray paths is calculated by considering (i) the position of the one or more point source locations; (ii) the position of the one or more receiver locations; (iii) the velocity of the one or more signals through different types of densities of materials; and (iv) the timing of the one or more signals as detected at the one or more receiver locations. In one embodiment, processing the one or more signals includes superimposing the one or more signals as detected at the one or more receiver locations.

In one embodiment, the one or more signals are emitted simultaneously or asynchronously relative to one another.

In one embodiment, at least one of the one or more receiver locations is located in or near a wellbore extending through at least part of the subterranean formation. In a further embodiment, at least one of the one or more point source locations is located in or near a wellbore extending through at least part of the subterranean formation. In another embodiment, the one or more receiver locations and the one or more point source locations are located in or near the same wellbore extending through at least part of the subterranean formation. The wellbore may be part of a horizontal well, vertical well, or deviated well. In a further embodiment, the one or more receiver locations are located in or near a first wellbore extending through at least part of the subterranean formation and the one or more point source locations are located in or near a second wellbore extending through at least part of the subterranean formation. The first wellbore may be substantially parallel to the second wellbore. In another embodiment, the first wellbore may be a vertical wellbore. In one embodiment, at least one of the one or more receiver locations is located in or near a first wellbore extending through at least part of the subterranean formation, at least one of the remaining one or more receiver locations is located in or near a second wellbore extending through at least part of the subterranean formation, and the one or more point source locations are located in or near a third wellbore extending through at least part of the subterranean formation, wherein the first wellbore is a vertical wellbore and the second and third wellbores are horizontal wellbores. The second and third wellbores may be one and the same.

In a preferred embodiment, the one or more receiver locations are located within about 150 m from the one or more point source locations.

In a further embodiment, a stationary signal point source is provided at each of the one or more point source locations and the one or more sonic or percussive signals are emitted by the signal point source. In another embodiment, a signal point source is provided in or near the subterranean formation and the one or more sonic or percussive signals are emitted by the signal point source, and emitting the one or more sonic or percussive signals from the one or more point source locations is achieved by moving the signal point source from one point source location to at least one other point source location.

In one embodiment, the receiver is a telecom fiber.

In one embodiment, at least one of the one or more sonic or percussive signals comprises one frequency or one range of frequencies. In another embodiment, at least one of the one or more sonic or percussive signals comprises two or more frequencies or two or more ranges of frequencies.

In one embodiment, the one or more ray paths comprise at least one of: a direct ray path, a refracted ray path, and reflected ray path.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. For US patent properties, it is noted that no claim element is to be construed under the provisions of 35 USC 112, sixth paragraph, unless the element is expressly recited using the phrase “means for” or “step for”.

1. A method for obtaining information about a subterranean formation, the method comprising:
emitting one or more sonic or percussive signals from one or more point source locations in or near the subterranean formation;
detecting the one or more signals at one or more receiver locations; and
processing the one or more signals detected at the one or more receiver locations to calculate the geometry of one or more ray paths travelled by each of the one or more signals from the one or more point source locations to the one or more receiver locations.

2. The method of claim 1 further comprising generating an image of the subterranean formation using the calculated geometry of the one or more ray paths.

3. The method of claim 1 wherein processing the one or more signals includes recording the timing of the one or more signals as detected at the one or more receiver locations.

4. The method of claim 1 wherein the geometry of the one or more ray paths is calculated from one or more of: (i) the position of the one or more point source locations; (ii) the position of the one or more receiver locations; (iii) the velocity of the one or more signals through different types of densities of materials; and (iv) the timing of the one or more signals as detected at the one or more receiver locations.

5. The method of claim 1 wherein processing the one or more signals includes superimposing the one or more signals as detected at the one or more receiver locations.

6. The method of claim 1 wherein the one or more signals are emitted simultaneously relative to one another.

7. The method of claim 1 wherein the one or more signals are emitted asynchronously relative to one another.

8. The method of claim 1 wherein at least one of the one or more receiver locations is located in or near a wellbore extending through at least part of the subterranean formation.

9. The method of claim 1 wherein at least one of the one or more point source locations is located in or near a wellbore extending through at least part of the subterranean formation.

10. The method of claim 1 wherein the one or more receiver locations are located in or near a first wellbore extending through at least part of the subterranean formation and the one or more point source locations are located in or near a second wellbore extending through at least part of the subterranean formation.

11. The method of claim 10 wherein the first and second wellbores are one and the same.

12. The method of claim 8 wherein the wellbore is or is part of a horizontal well, vertical well, or deviated well.

13. The method of claim 9 wherein the wellbore is or is part of a horizontal well, vertical well, or deviated well.

14. The method of claim 10 wherein the first wellbore is substantially parallel to the second wellbore.

15. The method of claim 10 wherein the first wellbore is a vertical wellbore.

16. The method of claim 1 wherein at least one of the one or more receiver locations is located in or near a first wellbore extending through at least part of the subterranean formation, at least one of the remaining one or more receiver locations is located in or near a second wellbore extending through at least part of the subterranean formation, and the one or more point source locations are located in or near a third wellbore extending through at least part of the subterranean formation, and wherein the first wellbore is a vertical wellbore and the second and third wellbores are horizontal wellbores.

17. The method of claim 15 wherein the second and third wellbores are one and the same.

18. The method of claim 1 wherein the one or more receiver locations are located within about 150 m from the one or more point source locations.

19. The method of claim 1 wherein a stationary signal point source is provided at each of the one or more point source locations and the one or more signals are emitted by the signal point source.

20. The method of claim 1 wherein a signal point source is provided in or near the subterranean formation and the one or more signals are emitted by the signal point source, and emitting the one or more signals from the one or more point source locations is achieved by moving the signal point source from one point source location to at least one other point source location.

21. The method of claim 1 wherein a receiver is provided at the one or more receiver locations and the receiver is a telecom fiber.

22. The method of claim 1 wherein at least one of the one or more signals comprises one frequency or one range of frequencies.

23. The method of claim 1 wherein at least one of the one or more sonic or percussive signals comprises two or more frequencies or two or more ranges of frequencies.

24. The method of claim 1 wherein the one or more ray paths comprise at least one of: a direct ray path, a refracted ray path, and a reflected ray path.

25. A system for obtaining information about a subterranean formation having one or more wellbores extending therein, the system comprising:
one or more signal sources for generating sonic or percussive signals at one or more point source locations in or near a first of the one or more wellbores;
a receiver located in or near a second of the one or more wellbores, the receiver for receiving the sonic or percussive signals generated by the one or more signal sources; and
a processor in communication with the receiver for recording and analyzing the sonic or percussive signals received by the receiver.

26. The system of claim 25 wherein the first and second of the one or more wellbores are one and the same.

27. The system of claim 25 wherein the receiver has one or more receiver locations, each of which being at a different location from one another in or near the second of the one or more wellbores for receiving the sonic or percussive signals.

28. The system of claim 25 wherein the processor is configured to calculate the geometry of one or more ray paths travelled by the sonic or percussive signals from the one or more signal sources to the receiver.

29. The system of claim 28 wherein the processor is configured to generate an image of the subterranean formation using the calculated geometry of the one or more ray paths.

30. The system of claim 25 wherein the processor is configured to record the timing of the sonic or percussive signals as detected by the receiver.

31. The system of claim 27 wherein the processor is configured to calculate the geometry of one or more ray paths travelled by the sonic or percussive signals from the one or more signal sources to the receiver; and wherein the processor calculates the geometry of the one or more ray paths from one or more of: (i) the position of the one or more point source locations; (ii) the position of the one or more receiver locations; (iii) the velocity of the sonic or percussive signals through different types of densities of materials; and (iv) the timing of the sonic or percussive signals as detected at the one or more receiver locations.

32. The system of claim 25 wherein the processor is configured to superimpose the sonic or percussive signals as detected by the receiver.

33. The system of claim 25 wherein the one or more signal sources generate the sonic or percussive signals simultaneously.

34. The system of claim 25 wherein the one or more signal sources generate the sonic or percussive signals asynchronously.

35. The system of claim 25 wherein the first of the one or more wellbores is a vertical wellbore.

36. The system of claim 25 wherein the first and/or the second of the one or more wellbores is a horizontal wellbore.

37. The system of claim 25 wherein the first and the second of the one or more wellbores are substantially parallel to one another.

38. The system of claim 25 further comprising at least one additional signal source for generating sonic or percussive signals at one or more additional point source locations in or near a third of the one or more wellbores.

39. The system of claim 38 wherein the first and the second of the one or more wellbores are horizontal wellbores and the third of the one or more wellbores is a vertical wellbore.

40. The system of claim 29 wherein the first and the second of the one or more wellbores are one and the same.

41. The system of claim 25 wherein the receiver is located within about 150 m from the one or more point source locations.

42. The system of claim 25 wherein the one or more signal sources are stationary.

43. The system of claim 25 wherein the one or more signal sources are movable from one location to at least one other location in or near the first of the one or more wellbores to provide the one or more point source locations.

44. The system of claim 25 wherein the receiver is a telecom fiber.

45. The system of claim 25 wherein each of the one or more signal sources generates sonic or percussive signals of one frequency or one range of frequencies, and the one frequency or range of frequencies of one of the one or more signal sources is the same as that of another one of the one or more signal sources.

46. The system of claim 25 wherein each of the one or more signal sources generates sonic or percussive signals of one frequency or one range of frequencies, and the one frequency or range of frequencies of one of the one or more signal sources is different from that of another one of the one or more signal sources.

47. The system of claim 25 wherein at least one of the one or more signal sources generates sonic or percussive signals of two or more frequencies or two or more ranges of frequencies, simultaneously or asynchronously.

48. The system of claim 28 wherein the one or more ray paths comprise at least one of: a direct ray path, a refracted ray path, and a reflected ray path.
